(19) United States
(12) Patent Application Publication
(10) Pub. No.: US 2018/0088789 A1
(43) Pub. Date: Mar. 29, 2018

(54) BUILDING AUTOMATION GRAPHICAL INTERFACE COMMAND CONFIGURATION

(71) Applicant: Siemens Schweiz AG, Zurich (CH)

(72) Inventors: James K. Han, Long Grove, IL (US); Andreas Hersche, Island Lake, IL (US); Elena Pokatayev, Volo, IL (US)

(73) Assignee: Siemens Schweiz AG, Zurich (CH)

(21) Appl. No.: 15/277,332

(22) Filed: Sep. 27, 2016

(51) Int. Cl. G06F 3/0484; G06F 3/0482

(52) U.S. Cl. CPC G06F 3/04847; G06F 3/0482

(57) ABSTRACT

Management systems, methods and mediums are provided for a building automation graphical interface command configuration. One method includes receiving a selection of a graphical element. The method includes receiving a selection of a command control type. The method includes associating the command control type with the graphical element to produce a command control. The method includes receiving at least one property for the command control. At least one property includes at least a parameter name that identifies a target of the command control. The method includes storing the command control. The method includes in response to a user selection or modification of the command control, processing a command to modify the target of the command control.

### CROSS-REFERENCE TO OTHER APPLICATIONS

This application also shares some subject matter in common with, but is otherwise unrelated to, the following commonly assigned patent applications, which are incorporated by reference to the extent permitted by law:
U.S. patent application Ser. No. 13/537,975, filed Jun. 29, 2012, and titled “Graphical Symbol Animation with Evaluations for Building Automation Graphics”.
U.S. patent application Ser. No. 14/866,077, filed Sep. 25, 2015, and titled “A Programmable Symbol Animation Pre-Processor for Building Automation Graphics”.

### TECHNICAL FIELD

The present disclosure is directed, in general, to management systems and, more particularly, to a programmable symbol animation pre-processor for building automation graphics.

### BACKGROUND OF THE DISCLOSURE

Building automation systems encompass a wide variety of systems that aid in the monitoring and control of various aspects of building operation. Building automation systems include security systems, fire safety systems, lighting systems, and HVAC systems. The elements of a building automation system are widely dispersed throughout a facility. For example, an HVAC system may include temperature sensors and ventilation damper controls, as well as other elements that are located in virtually every area of a facility. Similarly, a security system may have intrusion detection, motion sensors, video cameras and alarm actuators dispersed throughout an entire building or campus. Fire safety systems also include widely dispersed devices in the form of smoke alarms, pull stations and controllers. These building automation systems typically have one or more centralized control stations from which system data may be monitored and various aspects of system operation may be controlled and/or monitored.

Building automation systems may include vast numbers of devices and control points that may be communicated with, monitored, and controlled. Historically, management systems used to display and access data for monitoring and controlling operations of the building automation system have been relatively rigid in their user interface architecture. Because building automation systems are by nature unique to the layout and design of the particular building, maneuvering among displays of various elements of a complex, building automation system using a rigid user interface may be difficult and time consuming for building managers.

The U.S. patent application Ser. No. 13/537,975, filed Jun. 29, 2012, and titled “Graphical Symbol Animation with Evaluations for Building Automation Graphics” (the “'975 application”) discloses a novel system having a graphic user interface for displaying and animating graphical symbols for conveying information and alerts regarding a status of devices in one or more buildings. Such system as disclosed in the '975 application supports only one input for an animation of a property of a graphical element in an evaluation, which may be a property of a datapoint, which limits the flexibility for providing symbol animation reflecting information and alerts regarding the status of building devices.

The U.S. patent application Ser. No. 14/866,077, filed Sep. 25, 2015, and titled “A Programmable Symbol Animation Pre-Processor for Building Automation Graphics” (the “'077 application”) discloses a novel system for displaying graphical symbol animation with evaluations for building automation graphics using a programmable symbol animation pre-processor to enable multi-data points from the same or respective building devices to be employed in the symbol animation to reflect information and alerts regarding the status of multiple building device data points.

Designing an interface that is intuitive to view and use is a difficult and time-consuming task. Improved systems and methods for customizing a building management control interface are desirable.

### SUMMARY OF THE DISCLOSURE

Various disclosed embodiments relate to configuring customizable graphical user interface elements for executing commands and/or controlling the operation of a building's heating, ventilation, air conditioning, lighting, security, fire and other systems.

Various embodiments include management systems, methods, and mediums. One method, which may be implemented in a data processing system for displaying graphics, includes receiving a selection of a graphical element. The method includes receiving a selection of a command control type. The method includes associating the command control type with the graphical element to produce a command control. The method includes receiving at least one property for the command control. At least one property includes at least a parameter name that identifies a target of the command control. The method includes storing the command control. The method includes, in response to a user selection or modification of the command control, processing a command to modify the target of the command control.

Another embodiment includes a data processing system configured to display graphics. The data processing system includes a memory storing a plurality of graphical elements and a plurality of command control types, a display device, and a processor coupled to the memory and the display device. The processor receives a selection of a graphical element of the plurality of graphical elements. The processor receives a selection of a command control type of the plurality of command control types. The processor associates the command control type with the graphical element to produce a command control. The processor receives at least one property for the command control, wherein at least one property includes at least a parameter name that identifies a target of the command control. The processor stores the command control in the memory. In response to a user selection or modification of the command control, the processor processes a command to modify the target of the command control.

In various embodiments, the graphical element is one or more primitive elements, and is received through an interaction with a user to design or select the graphical element. In various embodiments, the graphical element is an instance of a symbol object. In various embodiments, the command control type is one of a slider, rotator, drop-down menu, or a spin button. In various embodiments, the command control type is one of a string field, a numeric field, or a password field. In various embodiments, the target is a data point of a building management system. In various embodiments, the user selection or modification of the command control is one of modifying a slider, a rotator, a drop-down menu, or a spin button. In various embodiments, the user selection or modification of the command control is one of filling in a string field, a numeric field, or a password field. In various embodiments, the command to modify the target of the command control includes modifying a data point of the building management system.

The foregoing has outlined rather broadly the features and technical advantages of the present disclosure so that those skilled in the art may better understand the detailed description that follows. Additional features and advantages of the disclosure will be described hereinafter that form the subject of the claims. Those of ordinary skill in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a management system in which various embodiments of the present disclosure are implemented;

FIG. 2 illustrates a block diagram of a data processing system that may be employed in the management system for implementing various embodiments of the present disclosure;

FIGS. 3A-3C illustrate examples of control elements of various control types in accordance with disclosed embodiments;

FIG. 4A illustrates a slider control in accordance with disclosed embodiments;

FIG. 4B illustrates parameters of a rotator control in accordance with disclosed embodiments;

FIG. 4C illustrates a runtime display of a rotator control in accordance with disclosed embodiments;

FIG. 4D illustrates a spin button in runtime mode in accordance with disclosed embodiments;

FIG. 5 illustrates a table of conditions for when a command is entered or cancelled in accordance with disclosed embodiments;

FIG. 6 illustrates a user interface for defining a command control for a rotator control with a thumb indicator in accordance with disclosed embodiments;

FIG. 7 illustrates a user interface for using a command control for a rotator control with a thumb indicator in accordance with disclosed embodiments;

FIG. 8 illustrates a flowchart of a process in accordance with disclosed embodiments.

### DETAILED DESCRIPTION

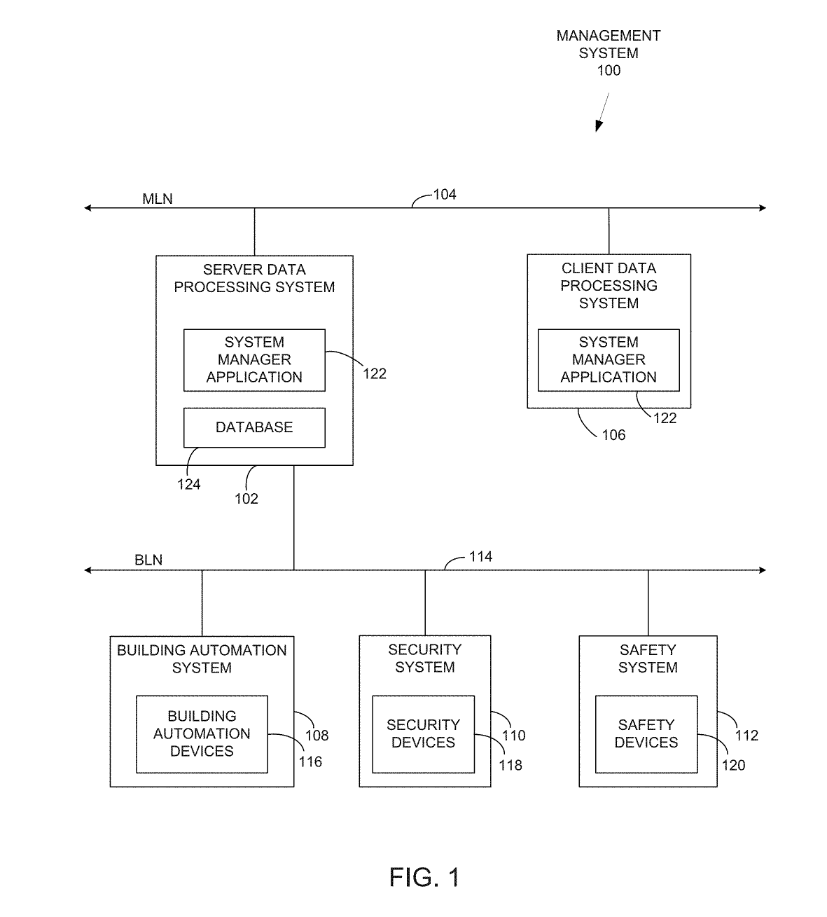

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device or system.

Typical graphical user interfaces for commanding are “hardcoded,” that is, permanently pre-programmed and fixed in the sense that the user interface (UI) elements the user manipulated are predetermined and inflexible without a reimplementation (recode) of the software program. Further, a user is not able to send any type of commands directly from the graphics subsystem, where the user is used to see all the relevant data. Instead, the workflow involved selecting the object in graphics and sending the command from the contextual pane and therefore losing “focus” on the relevant item.

Designing graphical user interfaces for “commanding” or controlling a building management system as discussed herein is inherently more complex than ordinary applications programming because the graphical interface computation is driven by a stream of input actions. All of these input actions performed by a program, including moving the mouse, clicking a mouse button, and typing a keystroke are processed by code which is compiled and constructed by the software developer. This code determines when an input action of potential interest to the application occurs. Such input actions are called “events”. Unfortunately, the code handling of these events is married to graphical elements which require new or modified programming logic that end users cannot provide, usually resulting in long wait times for enhancements/customizations to be released by the project development teams in potential future revisions of the software.

Various disclosed embodiments relate to configure customizable graphical user interface elements for executing commands and/or controlling the operation of a building's heating, ventilation, air conditioning, lighting, security, fire and other systems. In various embodiments, primitive elements (e.g., polygons, lines, text blocks, images, etc.), the basic building blocks for complex graphical symbols, contain and encapsulate commanding subsystem business logic. The command definition model, such as the command rule, reference target, object property, command parameter(s), and other configuration sub-structures, can be coupled to any graphics element and then be used as a method to trigger and execute commands to the system.

FIG. 1 illustrates a block diagram of management system 100 in which various embodiments of the present disclosure are implemented. In this illustrative embodiment, the management system 100 includes a server data processing system 102 connected, via a management level network (MLN) 104 to a client data processing system 106. The MLN 104 is a medium used to provide communication links between various data processing systems and other devices in the management system 100. MLN 104 may include any number of suitable connections, such as wired, wireless, or fiber optic links. MLN 104 may be implemented as a number of different types of networks, such as, for example, the internet, a local area network (LAN), or a wide area network (WAN). In some embodiments, elements of the management system 100 may be implemented in a cloud computing environment. For example, MLN 104 may include or be connected to one or more routers, gateways, switches, and/or data processing systems that are remotely located in a cloud computing environment.

In this illustrative embodiment, server data processing system 102 is operably connected to building automation system (BAS) 108, security system 110, and safety system 112 via building level network (BLN) 114. The BAS 108 is an environmental control system that controls at least one of a plurality of environmental parameters within a building or buildings, such as, for example, temperature, humidity, and/or lighting. The security system 110 controls elements of security within a building or buildings, such as, for example, location access, monitoring, and intrusion detection. The safety system 112 controls elements of safety within a building or buildings, such as, for example, smoke, fire, and/or toxic gas detection.

As depicted, the BAS 108 includes building automation devices 116, the security system 110 includes security devices 118, and the safety system 112 includes safety devices 120. In some embodiments, the BAS 108 may encompass the security system devices 118 and safety system devices 120. The devices 116-120 may be located inside or in proximity to one or more buildings managed using management system 100. The devices 116-120 are configured to provide, monitor, and/or control functions of the BAS 108, the security system 110, and/or the safety system 112 within one or more buildings managed using the management system 100. For example, without limitation, the devices 116-120 may include one or more field panels, field controllers, and/or field devices inside or in proximity to one or more buildings. More specifically, devices 116-120 may include one or more general-purpose data processing systems, programmable controllers, routers, switches, sensors, actuators, cameras, lights, digital thermostats, temperature sensors, fans, damper actuators, heaters, chillers, control valves, HVAC devices, detectors, motion sensors, glass-break sensors, security alarms, door/window sensors, smoke alarms, fire alarms, gas detectors, etc. The devices 116-120 may use the BLN 114 to exchange information with other components connected to the BLN 114, such as, for example, components within the BAS 108, the security system 110, the safety system 112, and/or the server data processing system 102. One or more of the devices 116-120 may also be connected via one or more field level networks (FLN) to a field panel or field controller for monitoring and controlling the respective field devices within a room, floor or other space of a building. For example, devices in the devices 116-120 may send and receive information to and from other devices in the devices 116-120 using one or more FLNs present in management system 100.

Various embodiments of the present disclosure are implemented in the management system 100. The management system 100 allows for systems and devices located throughout one or more buildings to be managed, monitored, and controlled from a single point and in a uniform manner. For example, a system manager application 122 may be installed on one or more workstations, such as server data processing system 102, client data processing system 106, and/or other devices connected via MLN 104. The system manager application 122 is a collection of software and associated data files that provides a user-modifiable and intuitive graphical user interface for allowing a user to monitor, review and control various points and devices in the management system 100. The system manager application 122 may include, for example, without limitation, executable files, user-layout-definition files, graphics control modules, an infrastructure interface, and/or a number of software extensions. In some embodiments, system manager application 122 may be an application framework as described in U.S. patent application Ser. No. 13/609,364, titled “Management System Using Function Abstraction for Output Generation” that is improved to employ the aspects of the present invention as described herein.

The server data processing system 102 includes a database 124 that stores information about the devices 116-120 within the management system 100. The database 124 includes one or more data models of data points, devices, and other objects in the management system 100. For example, the database 124 may store values for devices in the BAS 108 (e.g., temperature, alarm status, humidity). These values may be referred to as a point or data point. As referenced herein, a “point” or “data point” may be (i) any physical input or output to or from a respective controller, field device, sensor or actuator (i.e., devices 116, 118 or 120), or (ii) any virtual point associated with a control application or logic object within a field controller or field panel (or other devices 116-120) of the systems 108-112 that is measured, monitored or controlled. The database 124 may also store static information, such as model numbers, device types, and/or building and room-installation location information about devices in the management system 100. The database 124 may also store graphical models of one or more buildings managed by the management system 100. For example, the graphical models may include layouts and schematics of one or more rooms, floors and buildings managed by the management system 100.

In these illustrative embodiments, objects in the management system 100 (also referenced herein as “system objects”, “building device objects”, “graphic or symbol objects” or “data objects”) include anything that creates, processes or stores information regarding data points, such as physical devices (BAS controllers, field panels, sensors, actuators, cameras, etc.), and maintains data files, such as control schedules, trend reports, calendars, and the like.

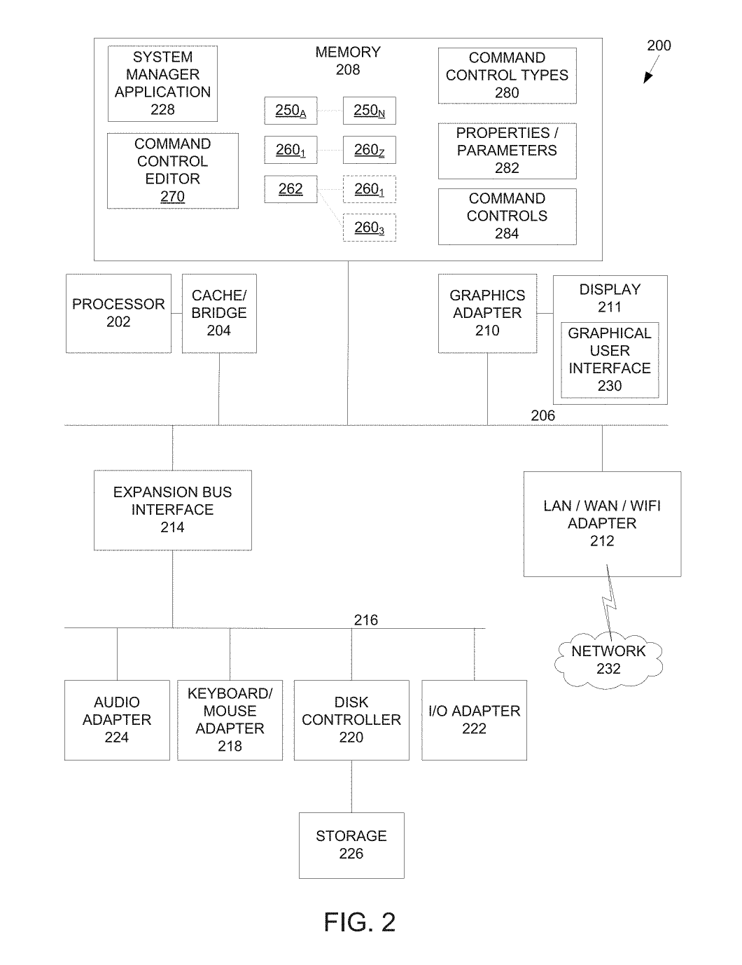

In various embodiments, the database 124 includes hierarchy definitions that identify relationships between objects in the system. For example, a hierarchy may include a folder for a “floor” in a building with multiple child folders in the form of “rooms”. Each “room” object, in turn, may have several child objects, such as “ventilation damper”, “smoke detector”, and “temperature sensor”. Such hierarchy definitions among objects may employ conventional BACnet structures or may take other forms. It will be appreciated that the use of hierarchical files in the management system 100 allows for technicians to define nearly any desirable hierarchy, the result of which is stored as one of the defined hierarchical files, as discussed further below. The database 124 stores files identifying different versions of hierarchies between the objects of the system, including those system or building device objects representative of the devices 116-120 (e.g., system or building device objects 250A-250N in FIG. 2).

The system manager application 122 may further include software extensions or services that provide operations of the management system 100. For example, the software extensions may include a print manager, a reporting subsystem, and a status propagation manager. For example, a reporting subsystem implemented on a workstation data processing system (e.g., server data processing system 102 or client data processing system 106) is a system that manages the acquisition of data values from the database 124 for the generation of various reports. Such reports may include, for example, trends for a temperature of a room or the like. In another example, the status propagation manager implemented on a workstation data processing system (e.g., server data processing system 102 or client data processing system 106) propagates alarm status information, among other things, to various other system or data objects in the management system 100. An example of a suitable alarm propagation system is provided in U.S. patent application Ser. No. 12/566,891, filed Sep. 25, 2009, which is assigned to the assignee of the present invention and is incorporated by reference herein to the extent permitted by law.

In various embodiments, system manager application 122 may, via server data processing system 102 or client data processing system 106, implement scheduling functions of the management system 100. The scheduling function is used to control points in the various systems based on a time-based schedule. For example, the scheduling function may be used to command temperature set points based on the time of day and the day of the week within the building automation devices 116.

The server data processing system 102 is connected to the BLN 114 and includes one or more hardware and/or software interfaces for sending and receiving information to and from the devices 116-120 in the BAS 108, the security system 110, and/or the safety system 112. For example, the server data processing system 102 may request and receive data regarding a status of one or more devices in the devices 116-120. The system manager application 122, via server data processing system 102 or client data processing system 106, provides a user with the functionality to monitor real-time information about the status of one or more devices and corresponding objects in the management system 100. The system manager application 122, via server data processing system 102 or client data processing system 106, also provides a user with the functionality to issue commands to control one or more devices and objects in the management system 100. For example, one or more of the devices 116-120 may implement a network protocol for exchanging information within the management system, such as building automation and controls network (BACnet) or local operation network talk (LonTalk) protocols.

The illustration of the management system 100 in FIG. 1 is not meant to imply physical or architectural limitations to the manner in which different illustrative embodiments may be implemented. Other components in addition to and/or in place of the ones illustrated may be used. Some components may be unnecessary in some illustrative embodiments. For example, any number of data processing systems may be used as workstations in the management system 100, while functions of the system manager application 122 may be implemented in different data processing systems in the management system 100. In other examples, embodiments of the management system 100 may not include one or more of the BAS 108, the security system 110, and/or the safety system 112.

FIG. 2 depicts a block diagram of a data processing system 200 in which various embodiments are implemented. The data processing system 200 is an example of one implementation of the server data processing system 102 in FIG. 1. The data processing system 200 is also an example of the client data processing system 106.

The data processing system 200 includes a processor 202 connected to a level two cache/bridge 204, which is connected in turn to a local system bus 206. The local system bus 206 may be, for example, a peripheral component interconnect (PCI) architecture bus. Also connected to the local system bus 206 in the depicted example are a main memory 208 and a graphics adapter 210. The graphics adapter 210 may be connected to a display 211.

Other peripherals, such as a local area network (LAN)/Wide Area Network (WAN)/Wireless (e.g. WiFi) adapter or network interface 212, may also be connected to the local system bus 206. An expansion bus interface 214 connects the local system bus 206 to an input/output (I/O) bus 216. The I/O bus 216 is connected to a keyboard/mouse adapter 218, a disk controller 220, and an I/O adapter 222. The disk controller 220 may be connected to a storage 226, which may be any suitable machine-usable or machine-readable storage medium, including, but not limited to, nonvolatile, hard-coded type mediums, such as read only memories (ROMs) or erasable, electrically programmable read only memories (EEPROMs), magnetic tape storage, and user-recordable type mediums, such as floppy disks, hard disk drives, and compact disk read only memories (CD-ROMs) or digital versatile disks (DVDs), and other known optical, electrical, or magnetic storage devices.

Also connected to the I/O bus 216 in the example shown is an audio adapter 224, to which speakers (not shown) may be connected for playing sounds. The keyboard/mouse adapter 218 is an input device that provides a connection for a pointing device (not shown), such as a mouse, trackball, trackpointer, etc. In some embodiments, the data processing system 200 may be implemented as a touch screen device, such as, for example, a tablet computer or a touch screen panel that also is an input device for the data processing system 200. In these embodiments, elements of the keyboard/mouse adapter 218 may be implemented in connection with the display 211 to provide an input device capability for the data processing system 200.

In various embodiments of the present disclosure, the data processing system 200 is implemented as an installed workstation with a system manager application 228 installed in the memory 208. The system manager application 228 is an example of one embodiment of system manager application 122 in FIG. 1. For example, the processor 202 executes program code of the system manager application 228 to generate graphical user interface 230 displayed on display 211. In various embodiments of the present disclosure, the graphical user interface 230 includes a display of symbols representing devices inside or in proximity to one or more buildings managed by the management system 100. The graphical user interface 230 provides an interface for a user to view information and alerts for one or more devices, objects, and/or points within the management system 100. The system manager application 228 may retrieve from the database 124 system or building device objects 250_{A}-250_{N} corresponding to devices and/or data points within the management system 100 that are currently represented graphically by symbols or by identifiers via the graphical user interface as further described herein, any of which can act as a target of a command control as described herein. Also, as further described herein, when generating a building graphic with a symbol, the system manager application 228 may also retrieve symbol objects 260₁-260_{Z} from the database 124 and generates instances of the symbol objects that are mapped to a data point of the building device object (e.g., 250_{A}) for generating a graphic symbol representing the respective building device and status of the associated data point. Each symbol object 260₁-260_{Z} can be a graphical element 260. In the illustrative embodiment in FIG. 2, the instances of the symbols or symbol objects 260₁ and 260₃ are depicted in dashed or broken lines and shown mapped to a building graphic object 262 as reflected by the dashed reference lines between the building graphic object 262 and the symbol object instances 260₁ and 260₃. In addition, the data processing system 200 may have a command control editor 270 that may be installed in memory 208 for access by the system manager application to create command controls as described herein. Memory 208 can also store command control types 280, properties/parameters 282, and command controls 284 described in more detail below. The graphical user interface 230 also provides an interface that is customizable to present the information and alerts in an intuitive and user-modifiable manner.

As used herein, a symbol or graphics symbol (e.g., symbols or symbol objects 260₁ and 260₃) is a reusable graphic image that may represent, for example, a piece of equipment, a device, a sensor, a floor, a component or an entity in association with the building graphic object 262, or as a control to control any of these elements. Symbols are stored in a library (e.g., in database 124) and may be used to display values for objects in the management system 100. Symbols may be associated with one or more object types and be bound to object-type properties to create substitutions to provide a dynamic, visual representation of changing values in the management system 100.

Those of ordinary skill in the art will appreciate that the hardware depicted in FIG. 2 may vary for particular implementations. For example, other peripheral devices, such as an optical disk drive and the like, also may be used in addition to or in place of the hardware depicted. The depicted example is provided for the purpose of explanation only and is not meant to imply architectural limitations with respect to the present disclosure.

In addition, although the command control editor 270 is depicted in FIG. 2 as being stored in memory 208 and comprising executable instructions to cause the processor 202 to perform processes described herein (alone or in combination with the system manager application 228), the pre-processor 270 may be implemented in a hardware circuit alone such as in an application-specific integrated circuit (ASIC) with the processor 202 or in an ASIC operatively interfacing with the processor 202.

One of various commercial operating systems, such as a version of Microsoft Windows™, a product of Microsoft Corporation located in Redmond, Wash. may be employed if suitably modified. The operating system may be modified or created in accordance with the present disclosure as described, for example, to implement graphic symbol animations with evaluations for building automation graphics.

LAN/WAN/Wifi adapter 212 (also referenced as a “network interface” herein) may be connected to one or more networks 232 via respective network communication channels of this network interface 212. For example, the network interface may separately connect to the MLN 104 and the BLN 114 as depicted in FIG. 1. As further explained below, each network 232 may be any public or private data processing system network or combination of networks, as known to those of skill in the art, including the Internet. Data processing system 200 may communicate over network 232 to one or more computers, which are also not part of the data processing system 200, but may be implemented, for example, as a separate data processing system 200. When required to interface with different physical networks 232 (e.g., Ethernet or RS-485 or other physical network), a respective network interface 212 is employed in the data processing system to connect to the corresponding physical network 232 (e.g., where MLN 104 and BLN 114 are different physical networks).

As described herein, primitive elements such as polygons, lines, text blocks, images, and others can contain and encapsulate commanding subsystem business logic. The command definition model, such as the command rule, reference target, object property, command parameter(s), and other configuration sub-structures, can be coupled to any graphics element and then be used as a method to trigger and execute commands to the system.

The list of primitive elements has been expanded by adding a command control element responsible for allowing the user to interact with it. This element can be configured to match the data type as well as input type of command parameters (e.g. slider vs. numeric edit field).

According to disclosed embodiments, the visual representation of the command control, such as a slider, rotator, or spin button, can be constructed with other primitive elements (e.g., polygons, lines, text blocks, image, etc.) and configured so that very complicated visual effects can be achieved. In addition, all the properties of the primitive elements can be animated using the existing infrastructure, as described by the '975 application.

The level of customization described herein adds tremendous power and flexibility to how the commanding user interface can be visualized, saving time, money and resources. Each of the controls created as described herein may have different appearances without requiring code changes. The coding of the functionality can be implemented once in the system as a look-less model, so that the visual representation can be configured to the preferences and abilities of the user.

Disclosed embodiments provide a user with a set of drawing elements with which the user can create shapes, complex graphics, templates, and are the building blocks for creating symbols. Elements can be formatted and they have properties that are configured in the Properties view. Elements can also be configured to issue commands. A user can also configure an element to display a tooltip when the user moves his mouse over the element on the canvas.

Disclosed embodiments can be implemented using a number of different graphical elements, such as an animation, ellipse, line, path, rectangle, polygon, text, or others. A control element allows the system to interact with a user to create an element on the canvas that can be configured as a control type such as a slider, rotator, drop-down menu, spin button, or a string, numeric, or password field, or other interactive element. According to various embodiments, the following information is used for configuring a command control: the property of object to be commanded, the command name, and, optionally, names and values of the command parameters.

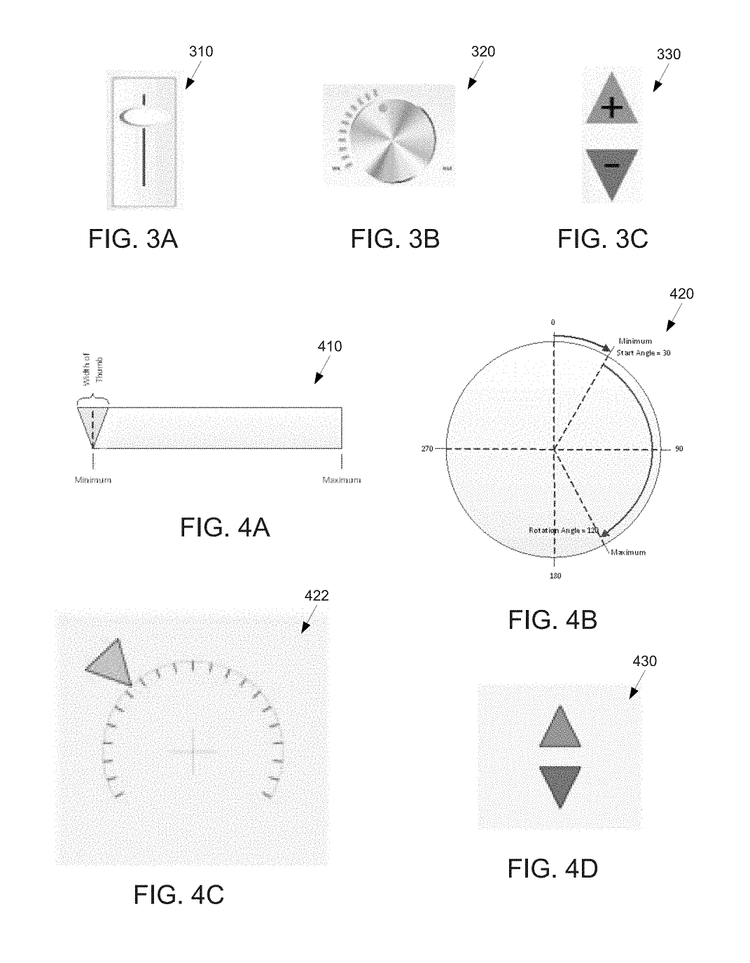

FIGS. 3A-3C illustrate examples of control elements of various control types in accordance with disclosed embodiments. FIG. 3A illustrates an example slider control 310. FIG. 3B illustrated an example rotator control 320. FIG. 3C illustrates an example spin button control 330.

Each control type can have specific properties. Some examples of these are described below.

A “dropdown” control type allows the user to draw a selection box and visualize and change enumeration values, such as Command Priority. Sample properties are illustrated in Table 1.

TABLE 1
Command Control: Dropdown

| Property | Description |
|---|---|
| Parameter | Enter the parameter name that matches the parameter name of |
| Name | the command configuration of the data point in the Object |
| | Model. |
| Font | Specifies the font family. |
| Family | An invalid font family in the evaluation defaults to a font |
| | close to the “MS Sans Serif” family |
| Font Size | The font size with the optional unit, e.g. 14 or 12pt. The |
| | default unit is “px”. |
| | Following units are supported: |
| | px (pixels, device-independent units) = 1/96th inch per unit |
| | in (inches), 1 in = 96px |
| | cm (centimeters), 1 cm = 96/2.54 px |
| | pt (points), 1pt = 96/72 px |

A “numeric” control type allows the user to draw an object to visualize and change analog values in numeric form. Accepts numeric keyboard input. Sample properties are illustrated in Table 2.

TABLE 2
Command Control: Numeric

| Property | Description |
|---|---|
| Parameter | Enter the parameter name that matches the parameter name of |
| Name | the command configuration of the data point in the Object |
| | Model. |
| Minimum | This property specifies the minimal value the control allows to |
| | edit a numeric input. If the property is blank, the minimum |
| | value of the command parameter definition is used. |
| Maximum | This property specifies the maximal value the control |
| | allows to edit a numeric input. If the property is blank, the |
| | maximal value of the command parameter definition is used. |

A “string” control type allows the user to draw an object to visualize and change text, such as descriptions. This control type accepts keyboard input. Sample properties are illustrated in Table 3.

TABLE 3
Command Control: String

| Property | Description |
|---|---|
| Parameter | Enter the parameter name that matches the parameter name of |
| Name | the command configuration of the data point in the Object |
| | Model. |
| Minimum | Enter the minimum number of allowable characters. |
| Length | |
| Maximum | Enter the maximum number of allowable characters. |
| Length | |

A “password” control type allows the user to draw an object to visualize and change passwords. This control type accepts keyboard input. Sample properties are illustrated in Table 4.

TABLE 4
Command Control: Password

| Property | Description |
|---|---|
| Parameter | Enter the parameter name that matches the parameter name |
| Name | of the command configuration of the data point in the Object |
| | Model. |
| Minimum | Use the up and down arrows to specify the number of |
| Length | allowable characters allowed. |
| Maximum | Enter the allowable maximum number of characters allowed. |
| Length | Default value is set to 2147483647. |
| Password | Enter the default character to represent the masking |
| Character | characters(s) when the user enters the password. Default is |
| | set to a dot. |

A “slider” control type allows the user to draw an object and visualize and change analog values in a slider format. FIG. 4A illustrates a slider control 410 in accordance with disclosed embodiments. This illustration of slider 400 displays the Minimum and Maximum properties and how the thumb lines up with the slider in regards to the width of the Thumb. Sample properties are illustrated in Table 5.

TABLE 5
Command Control: Slider

| Property | Description |
|---|---|
| Parameter | Type the parameter name that matches the parameter name in |
| Name | the Command configuration of the data point in the Object |
| | Model. |
| Minimum | Enter the minimum value on the slider spectrum. |
| Maximum | Enter the maximum value on the slider spectrum. |
| Snap to | Enables the slider thumb to move incrementally to the closest |
| Ticks | tick when the position of the slider changes. |
| Tick | Enter the tick frequency. For example: 2, 4, 6, 8 or 10, 20, 30. |
| Frequency | The tick marks start at the Minimum property value and |
| | continue until the value of the Maximum property value is |
| | reached. |
| Update | Enter a value in milliseconds that specifies how quickly the |
| Interval | value is updated as the thumb moves along the rotator. |
| Drag | When enabled, when a user clicks and drags the thumb along |
| Shadow | the slider on the canvas, the thumb shadow remains on the |
| | slider. When a user releases the drag (mouse button), the |
| | command is sent. Behind the moving element, the element |
| | with the original value is semi-transparent. This allows the |
| | actual data point value to always be visible and to display the |
| | amount of time it takes to update. This property is enabled by |
| | default. |

A “rotator” control type allows the user to draw an object and visualize and change analog values in a rotational image using a rotational sliding motion. FIG. 4B illustrates parameters of a rotator control 420 in accordance with disclosed embodiments. FIG. 4C illustrates a runtime display of a rotator control 422. Sample properties are illustrated in Table 6.

TABLE 6
Command Control: Rotator

| Property | Description |
|---|---|
| Parameter | Enter the parameter name that matches the parameter name |
| Name | of the command configuration of the data point in the Object |
| | Model. |
| Minimum | Enter the minimum value of the thumbs position on the |
| | control. |
| | If the property is blank, the minimum value of the command |
| | definition is used. |
| Maximum | Enter the maximum value of the thumbs position on the |
| | control. |
| | If the property is blank, the minimum value of the command |
| | definition is used. |
| Start | Enter the value of the start angle that represents the |
| Angle | minimum value. |
| Rotation | Enter the value that covers the distance of the Start Angle |
| Angle | property value and the Maximum property value of the |
| | control. For example, if the minimum angle is −120; the |
| | maximum angle value is +120, the Rotation Angle value = |
| | 240. |
| | The default value is: 180 |
| Snap to | Enables the rotator pointer to move incrementally to the |
| Ticks | closest tick when the position of the pointer changes. |
| Tick | Enter the tick frequency. For example: 2, 4, 6, 8 or 10, 20, 30. |
| Frequency | The tick marks start at the Minimum property value and |
| | continue until the value of the Maximum property value is |
| | reached. |
| Update | Enter a value that specifies the interval for the data point |
| Interval | changes. The default value is: 500. |
| | If the value is larger than 100, the delay is minimal |
| | between two modifications of the data point. |
| | If the value is less than 1 the update delay is longer. |
| | NOTE: The data point can be modified immediately upon |
| | release of the data point. |
| Drag | When enabled, when the rotator pointer moves, the pointer |
| Shadow | shadow is visible on the rotator. Behind the moving element, |
| | the element with the original value is semi-transparent. This |
| | allows the actual data point value to always be visible and to |
| | display the amount of time it takes to update. This property is |
| | enabled by default. |

A “spin button” control type allows the user to draw an object and visualize incrementing and decrementing analog values in a spin button format. FIG. 4D illustrates a spin button 430 in runtime mode. Sample properties are illustrated in Table 7.

TABLE 7
Command Control: Spin Button

| Property | Description |
|---|---|
| Parameter | Type the parameter name that matches the parameter name in |
| Name | the Command configuration of the data point in the Object |
| | Model. |
| Minimum | Enter the minimum value on the spin spectrum. |
| Maximum | Enter the maximum value on the spin spectrum. |
| Change | Specifies the amount by which the value changes. |
| Amount | |
| Update | Specifies the delay in milliseconds before a datapoint |
| Delay | modification (command execution) after a period of inactivity. |

Other general properties for command and navigation can be associated with any of the control types. Table 8 illustrates examples of these other general command and navigation properties.

TABLE 8
Command and Navigation Properties

| Property | Description |
|---|---|
| Target | Allows a user to enter the receiving object of the command |
| | or the new primary selection. |
| | A user can enter the following information: |
| | Data point reference: Allows a user to enter a reference |
| | that is used the command target or as the new primary |
| | selection. The Navigation Parameter property provides |
| | additional context when used with the target. |
| | Application name and/or file name: Allows a user to |
| | enter an application or file name that displays when |
| | commanded. |
| | Application example: WinWord mydoc.doc |
| | File example: C:\Data Files\Readme.txt |
| | Web Address (URL): Allows a user to type a URL that |
| | displays in the default browser. |
| | Example: http://www.domain.com |
| Command | Allows a user to select a command name from a list of |
| Name | commands. |
| | The Command Name must match the Name of the |
| | Command in the Models and Functions Command |
| | Configuration section. |
| Parameter | Allows a user to enter context information, either command |
| | parameter(s) or arguments, for the new primary selection |
| | based on the information in the Target field. |
| | Commanding examples: |
| | Value |
| | Value; Priority |
| | Value = 72.0 |
| | Value = 72.0; Priority = 8 |
| Trigger | Allows a user to select how the navigation is triggered: |
| | Single click |
| | Double click |
| Description | Allows a user to enter a brief descriptive text associated |
| | with the navigation target. When a user places his mouse |
| | over the element, the text displays as a tooltip. |
| Cursor | Allows a user to select which cursor displays when the user |
| | moves the mouse over the element on the graphic: Default |
| | or Hand. |
| Command | Allows a user to enable the element to initiate sending the |
| Trigger | command. Disabled by default. |
| Disabled | Allows a user to disable the command. If checked, the |
| | command is disabled. |
| Disabled | Allows a user to specify how the command displays when it |
| Style | is disabled: |
| | Grayed - the entire element is grayed out. |
| | None - No difference from when the element is enabled |
| | or disabled. |
| | Hidden - the entire element is hidden. |
| | The default style is set to Grayed. |

Each element has properties associated it that are configured in a properties view. Each property belongs to a category of properties. The system can display, to a user, a brief description of the property, or a more detailed description of the property, including property type, allowable input values, and the default value. Each element property can be animated. The animation can be implemented by creating evaluations for a property. The evaluation value is can be added to the design value.

Each of the elements can be configured to send commands from within a graphic, as described in more detail below.

A “command symbol,” as used herein refers to graphic element that contains elements that have been configured to send commands from within the graphic. The command symbol represents the command. The commands can be initiated, for example, by receiving a user's selection (such as a mouse click) on the command symbol or in response to parameter values. Each symbol style can have a default command symbol.

The system can interact with a user to create a command symbol and associate the command symbol with a specific data point.

For example, a user can create a command symbol and associate it to a data point, then designate it as the as the default command symbol for that data point, so that the system displays that command symbol when the data point is drag-and-dropped on to the “canvas” of a building management system editor.

The system can interact with user to create a command symbol graphic element that functions as a button to manually send a command. For example, the system and user can create a command symbol that when clicked, sends a “release” command to the data point's present value property.

To do so, the user can select the elements to draw and design a command button using the graphics editor formatting features. Then, the user can use a menu selection to select the “release” command. The user then selects the “present value” property for the target data point. The system creates that command symbol by associating the selected command with the graphic element, the data point, and the property. After saving, the system responds to a selection of that command symbol by executing the selected “release” command on the present value property of the associated data point. The command symbol can be saved with a name and any other relevant parameters so that it can be used and reused when needed.

Since the command control shows the actual value, which can change because it is tied to system updates, the control will display an indicator when the user starts editing the value, to indicate that the edit session started. During the edit session, the system will not update the value of the control.

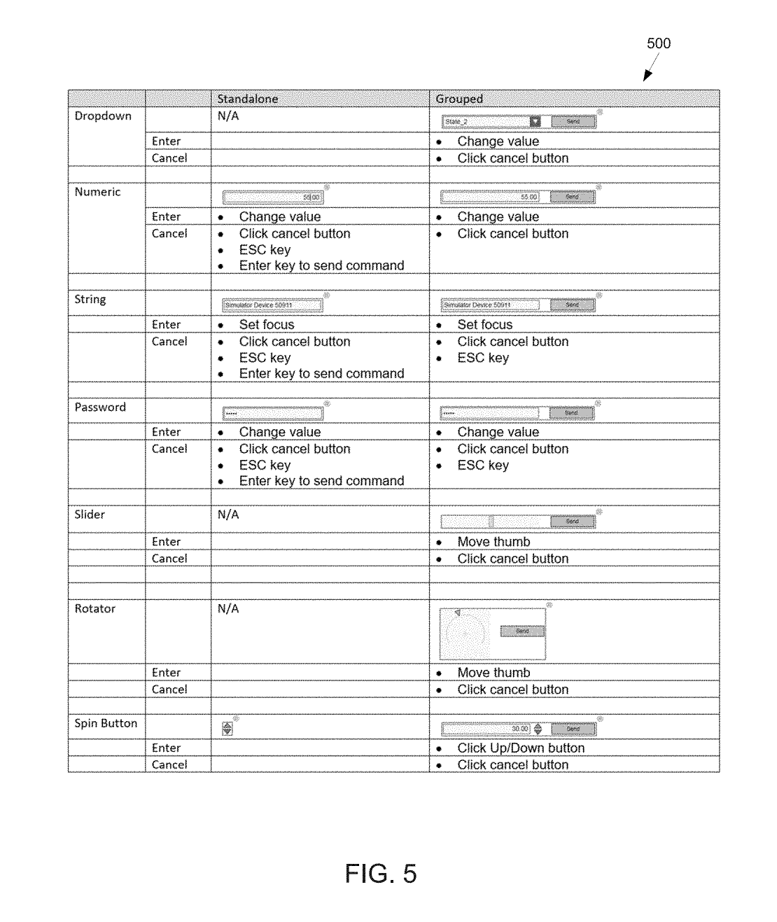

In general, an edit session lasts until one either the command is entered and sent or editing is canceled. FIG. 5 illustrates a table of conditions 500 for when a command is entered or cancelled.

Disclosed embodiments allow a user to design any graphical element and join it to command symbols as disclosed herein. For example, the user can create a slider, rotator or spin button and use any type of basic element, such as rectangle, ellipse, or triangle to visually style the “thumb” indicator or up/down buttons. The thumb or up/down buttons can also be a group or a symbol. The thumb or up/down buttons can be stored in a parent/child relation with the slider, rotator or spin button.

The system can associate the child with the slider, rotator, or spin button. According to various embodiments, the thumb or the up/down button are the only visuals for the slider, rotator, or spin button. In these embodiments, the user can create any visual comprised of simple elements to represent the thumb or up/down button which maximizes the visual customizability of these types of control.

When sending a command, the system can use the property or properties of the object to be commanded, the command name, and, optionally, names and values of the command parameters.

A command can be grouped into two categories, standalone and grouped.

A standalone command includes commands with no prompted parameters, which use just a button, commands with just one prompted command parameter, and commands with hardcoded parameter values. In case of the standalone command, the element itself sends out the command, which means the element knows the commanding information, such as the property to be commanded, the command name, and the name and value of command parameter. The element is the command trigger, so that it sends the command.

A grouped command includes commands that require a send button with at least one prompted command parameter, commands with multiple command parameters, and commands with multiple representations for the same command parameter, such as a numeric control plus a slider. In case of a grouped command, the group knows about the command, which means the group knows the commanding information, such as the property to be commanded, the command name, and the name and value of command parameter. The group is configured as a command group. The child element supplies input for named parameter, and the child element is the command trigger, so that it sends the command.

In various embodiments, only the command group knows about the command by configuring the properties target, command name and parameter. The children of the command group do not have any knowledge about the command, which means that the children's properties can be empty.

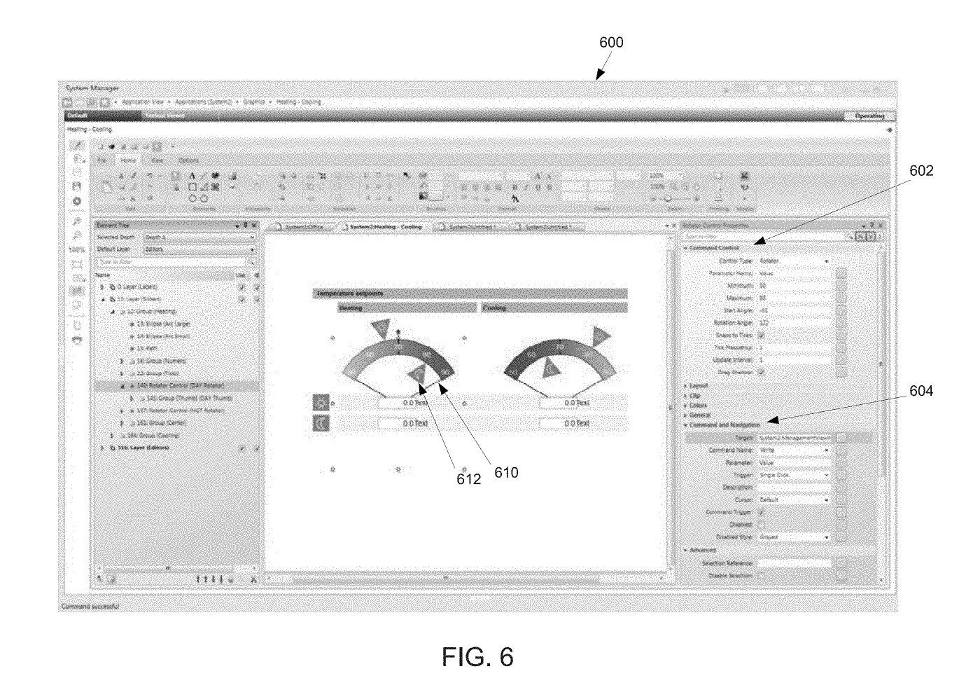

FIG. 6 illustrates a user interface 600 for defining a command control for a rotator control 610 with a thumb indicator 612. In this example, rotator control 610 is for adjusting heating temperature setpoints in a building management system. Rotator control 610 has command control properties 602 and command and navigation properties 604.

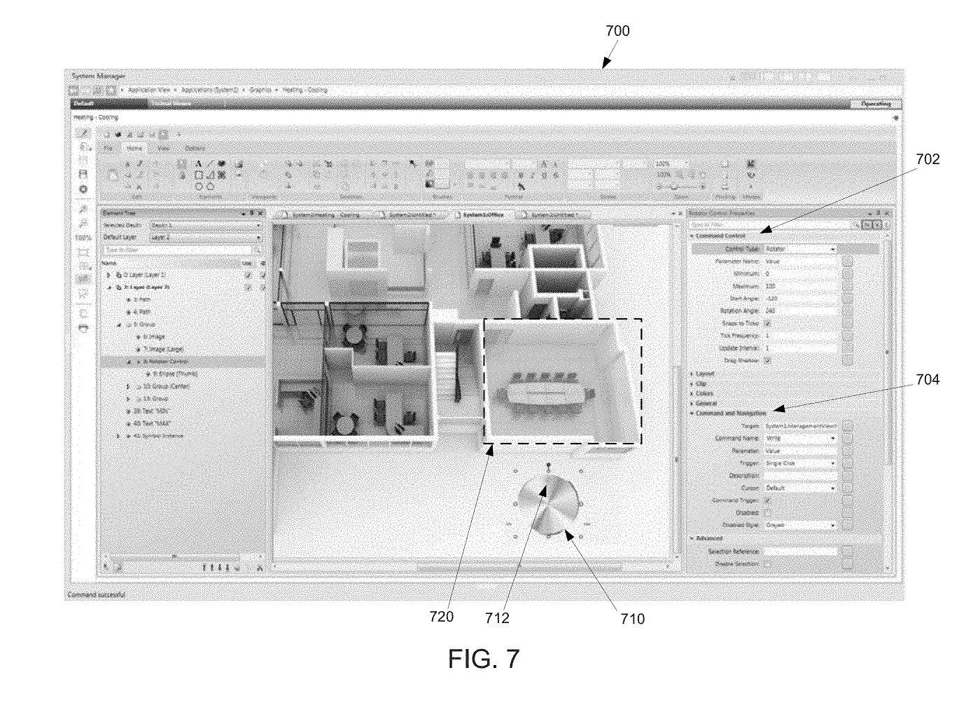

FIG. 7 illustrates a user interface 700 for using a command control for a rotator control 710 with a thumb indicator 712. In this example, rotator control 710 is for adjusting the temperature in a building management system, in this case for the displayed room 720. Rotator control 710 has command control properties 702 and command and navigation properties 704. As a user manipulates rotator control 710, rotator control 710 issues commands to the building management system to adjust the temperature of room 720 in accordance with the command and navigation properties 704 including the “Target” property as described in reference to Table 8 and elsewhere herein. In user interface 700, the color in which room 720 is displayed can be changed by the system 100 or 200 in response to the rotator control 710 being selectively manipulated to illustrate the change in temperature setpoint (i.e., the Target to be controlled in this example) in the room 720.

The graphical user interfaces of FIGS. 6 and 7 are examples of interfaces generated by the data processing system 200 and the system manager application 228. In this illustrative embodiment, the graphical user interface comprises a multi-area or multi-pane display window displayed on a display device (e.g., display 211 in FIG. 2). In FIG. 7, the graphical user interface includes a display of a building graphic and a plurality of associated panes or windows. In this example, the building graphic is a graphical representation of a floor of a building.

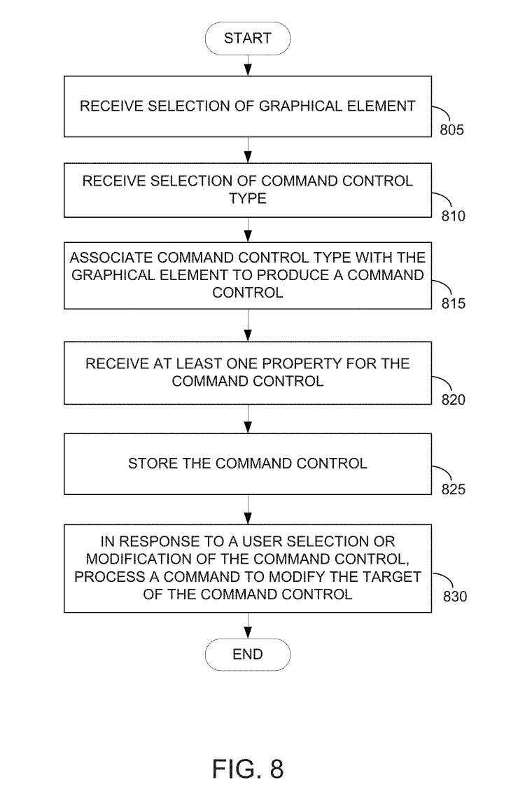

FIG. 8 illustrates a flowchart of a process in accordance with disclosed embodiments that can be performed by a building management system or one or more data processing systems as disclosed herein, referred to generically below as the “system.” The process described below can be used in conjunction with any of the features described herein.

The system receives a selection of a graphical element (805). The graphical element can be one or more primitive elements, and can be received, for example, through an interaction with a user to design or select the graphical element. The graphical element can be an instance of a symbol object as described herein.

The system receives a selection of a command control type (810). The command control type can be one of a slider, rotator, drop-down menu, spin button, or a string, numeric, or password field, or other interactive element.

The system associates the command control type with the graphical element to produce a command control (815).

The system receives at least one property for the command control (820). The at least one property includes at least a parameter name that identifies a target of the command control. The target can be, for example, a data point or other controllable aspect of the building management system.

The system stores the command control (825).

The system thereafter, in response to a user selection or modification of the command control, processes a command to modify the target of the command control (830). The user selection or modification of the command control can include modifying the slider, rotator, drop-down menu, or spin button, or filling in a string, numeric, or password field. Processing the command to modify the target of the command control can include modifying the data point or other controllable aspect of the building management system.

The processes described herein provide an improvement to the operation of the building management system by enabling a user to design and use custom command controls without requiring reprogramming or reconfiguration of the user interface.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 200 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

In addition, the steps of various methods or processes described in connection with the embodiments disclosed herein may be embodied directly in hardware, in instructions executed by a processor (e.g., processor 202 and pre-processor 270 of the data processing system 200), or in a combination of the two. Instructions to be executed by a processor may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transitory storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC § 112 unless the exact words “means for” are followed by a participle.

What is claimed is:

1. A method in a data processing system, the method comprising:
receiving a selection of a graphical element;
receiving a selection of a command control type;
associating the command control type with the graphical element to produce a command control;
receiving at least one property for the command control, wherein at least one property includes at least a parameter name that identifies a target of the command control;
storing the command control; and
in response to a user selection or modification of the command control, processing a command to modify the target of the command control.

2. The method of claim 1, wherein the graphical element is one or more primitive elements, and is received through an interaction with a user to design or select the graphical element.

3. The method of claim 1, wherein the graphical element is an instance of a symbol object.

4. The method of claim 1, wherein the command control type is one of a slider, rotator, drop-down menu, or a spin button.

5. The method of claim 1, wherein the command control type is one of a string field, a numeric field, or a password field.

6. The method of claim 5, wherein the target is a data point of a building management system.

7. The method of claim 1, wherein the user selection or modification of the command control is one of modifying a slider, a rotator, a drop-down menu, or a spin button.

8. The method of claim 1, wherein the user selection or modification of the command control is one of filling in a string field, a numeric field, or a password field.

9. The method of claim 1, wherein processing the command to modify the target of the command control includes modifying a data point of the building management system.

10. A data processing system configured to display graphics, the data processing system comprising:
a memory storing a plurality of graphical elements and a plurality of command control types;
a display device; and
a processor coupled to the memory and the display device, where the processor:
receives a selection of a graphical element of the plurality of graphical elements;
receives a selection of a command control type of the plurality of command control types;
associates the command control type with the graphical element to produce a command control;
receives at least one property for the command control, wherein at least one property includes at least a parameter name that identifies a target of the command control;
stores the command control in the memory; and
in response to a user selection or modification of the command control, processes a command to modify the target of the command control.

11. The data processing system of claim 10, wherein the graphical element is one or more primitive elements, and is received through an interaction with a user to design or select the graphical element.

12. The data processing system of claim 10, wherein the graphical element is an instance of a symbol object.

13. The data processing system of claim 10, wherein the command control type is one of a slider, rotator, drop-down menu, or a spin button.

14. The data processing system of claim 10, wherein the command control type is one of a string field, a numeric field, or a password field.

15. The data processing system of claim 10, wherein the target is a data point of a building management system.

16. The data processing system of claim 10, wherein the user selection or modification of the command control is one of modifying a slider, a rotator, a drop-down menu, or a spin button.

17. The data processing system of claim 10, wherein the user selection or modification of the command control is one of filling in a string field, a numeric field, or a password field.

18. The data processing system of claim 10, wherein processing the command to modify the target of the command control includes modifying a data point of the building management system.

19. A non-transitory machine-readable storage medium encoded with executable instructions that, when executed, cause one or more processors to:
receive a selection of a graphical element of the plurality of graphical elements;
receive a selection of a command control type of the plurality of command control types;
associate the command control type with the graphical element to produce a command control;
receive at least one property for the command control, wherein at least one property includes at least a parameter name that identifies a target of the command control;
store the command control in the memory; and
in response to a user selection or modification of the command control, processes a command to modify the target of the command control.

20. The non-transitory machine-readable storage medium of claim 19, wherein the command control type is one of a slider, rotator, drop-down menu, a spin button, a string field, a numeric field, or a password field.
